(19) United States
(12) Patent Application Publication
(10) Pub. No.: US 2007/0006620 A1
(43) Pub. Date: Jan. 11, 2007

(54) Steering lock device

(76) Inventor: Keisuke Fukushima, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 11/480,400

(22) Filed: Jul. 5, 2006

(30) Foreign Application Priority Data
Jul. 7, 2005 (JP) 2005-199072

(51) Int. Cl. B60R 25/02

(52) U.S. Cl. 70/186

(57) ABSTRACT

A steering lock device according to the present invention includes: a lock bolt for locking or unlocking a movable member that operates in conjunction with steering operation; first and second position detection members for detecting an operating position of the lock bolt; a position determination member for determining an operating state of the lock bolt based on a detection signal from the position detection members, the first and second position detection members being so placed as to generate a time difference between detection time points of a locked position and an unlocked position by the first and second position detection members; and a failure determination means for determining the presence of a failure based on an actual detection time difference and on a preset allowable range of the time difference.

### BACKGROUND OF THE INVENTION

The present invention relates to an electric steering lock device for locking the steering of automobiles and the like.

A conventional steering lock device used for locking the steering of automobiles and the like for the antitheft purpose has an engagement recess section formed on the outer periphery of a steering shaft which rotates in response to steering operation. When a driver performs an operation to stop the engine of the automobile with a key, a slidable lock bolt goes into and engages with the engagement recess section, by which the rotation of the steering shaft is regulated and the steering is locked. Otherwise, when the driver performs an operation to start the engine with the key, the lock bolt goes back from the engagement recess section and the engagement is cancelled, by which the regulation against the rotation of the steering shaft is cancelled and the steering is unlocked.

Information on the conventional art with respect to such steering lock devices is found in JP 2004-299658 A (referred to as “the patent document” hereinafter).

The patent document has disclosed a lock device having a position detection means composed of a pair of switches which can detect whether a lock bolt is positioned in a locked state or an unlocked state based on signals outputted from these switches. More specifically, as shown in FIG. 14, when the lock bolt in this lock device is in the locked state, a LOW signal is outputted from a switch S1, while a HI signal is outputted from a switch S2. By contrast, when the lock bolt is in the unlocked state, a HI signal is outputted from the switch S1, while a LOW signal is outputted from the switch S2. Consequently, the microcomputer can detect the operation state of the lock bolt by detecting the LOW signal or the HI signal inputted into the ports that are connected to the switches S1, S2.

Moreover, in the lock device in the patent document, the presence of failures of the switches S1, S2 can be determined based on signals inputted with the switches. That is, in the case where the switch S1 fails in an open (cut-off) state, the HI signal continues to be outputted from the switch S1. Therefore, the microcomputer cannot determine abnormal conditions in the unlocked state, but can determine abnormal conditions in the locked state since the HI signal is inputted from both the switches S1, S2. Moreover, in the case where the switch S1 fails in a short-circuited state, the LOW signal continues to be outputted from the switch S1. Therefore, the microcomputer cannot determine abnormal conditions in the locked state, but can determine abnormal conditions in the unlocked state since the LOW signal is inputted from both the switches S1, S2. Moreover, in the case where the switch S2 fails in the open (cut-off) state, the HI signal continues to be outputted from the switch S2. Therefore, the microcomputer cannot determine abnormal conditions in the locked state, but can determine abnormal conditions in the unlocked state since the HI signal is inputted from both the switches S1, S2. Moreover, in the case where the switch S2 fails in the short-circuited state, the LOW signal continues to be outputted from the switch S2. Therefore, the microcomputer cannot determine abnormal conditions in the unlocked state, but can determine abnormal conditions in the locked state since the LOW signal is inputted from both the switches S1, S2.

However, in the lock device in the patent document, when either one of the switches S1, S2 fails, abnormal conditions cannot be determined unless the operation state is shifted to either the locked state or the unlocked state. Consequently, when any one of switches fails during operation of the lock device, sometimes abnormal conditions cannot be determined until the next operation of the lock device is completed.

For example, in the case where the switch S1 fails in the open state (HI) during a shifting operation from the locked state (S1=LOW, S2=HI) to the unlocked state (S1=HI, S2=LOW), the failure of the switch S1 cannot be detected in the unlocked state. When a next shifting operation to the locked state is performed and then is completed, detection of abnormal conditions of the switch S1 becomes possible. It can be said that the HI signal is outputted by both the switches in two cases: one is the case where the switch S1 fails in the open state when the lock bolt is in the locked state; and the other is the case where the switch S2 fails in the short-circuited state when the lock bolt is in the unlocked state. Since the microcomputer cannot determine whichever switch, the switch S1 or the switch S2, fails during whichever operation state of the lock bolt, the lock bolt may become inoperable under such the failure conditions. In such a case, the locked state of the steering cannot be cancelled, and this makes a drawback that the automobile cannot run till repair work is performed.

### SUMMARY OF THE INVENTION

An object of the present invention is to provide, in view of the above-mentioned conventional drawback, a steering lock device capable of swiftly determining failures in switches that detect an operating position of a lock bolt and capable of enhancing responsiveness to the failures.

In order to accomplish the object, a steering lock device of the present invention has:

a lock bolt for locking or unlocking a steering upon engagement with a movable member that operates in conjunction with operation of the steering or upon release from the engagement;

first and second position detection members for detecting an operating position of the lock bolt;

a position determination member for determining an operating state of the lock bolt based on detection signals from the position detection members,

the first and second position detection members being so placed as to generate a time difference between a point of time when a locked position and an unlocked position of the lock bolt are detected by the first position detection member and a point of time when the locked position and the unlocked position of the lock bolt are detected by the second position detection member; and

a failure determination member for determining a presence of a failure of the first or second position detection member based on an actual detection time difference by the first and second position detection members and on a preset allowable range of the time difference.

In the steering lock device of the present invention, the locked state or the unlocked state of the lock bolt can reliably be determined by two position detection members. Furthermore, the first and second position detection members are so placed that their detection time points are different from each other to generate a time difference. Since the failure state of the position detection members is further determined based on an actual time difference and a preset allowable range of time difference, occurrence of a failure of the position detection members can reliably be determined during the one operation of the lock bolt. As a result, it becomes possible to cope with the aftermath of the failure with expedition.

More specifically, in the case where a failure of the position detection members occurs during a shifting operation of the lock bolt from the locked state to the unlocked state, it is possible to prevent the lock bolt from shifting again to the locked position. As a result, it is possible to prevent the lock bolt from becoming the inoperable state at the locked position and from making the automobile incapable of running.

In the steering lock device of the present invention, it is desirable that when it is determined by the failure determination member that the first or second position detection member has a failure, a shifting operation of the lock bolt to the locked state is prohibited.

In this case, it is desirable that when it is determined that the first or second position detection member has a failure during a shifting operation of the lock bolt from the locked state to the unlocked state, a shifting operation of the lock bolt to the locked state after completion of an unlocking operation of the lock bolt is prohibited.

Moreover, it is desirable that when it is determined that the first or second position detection member has a failure at a start of a shifting operation of the lock bolt from the unlocked state to the locked state, the shifting operation of the lock bolt to the locked state is prohibited. Here, “at start” means a time when a steering locking processing by the failure determination member has already started and when an actual shifting operation of the lock bolt from the unlocked state to the locked state has not yet started.

Further, it is desirable that when it is determined that the first or second position detection member has a failure after a start of the actual shifting operation of the lock bolt from the unlocked state to the locked state, a next shifting operation of the lock bolt to the locked state is prohibited once the shifting operation of the lock bolt to the locked state is completed and then a shifting operation of the lock bolt to the unlocked state is completed.

According to the steering lock device of the present invention, the first and second position detection members are so placed as to generate a time difference between points of time when a locked position and an unlocked position of the lock bolt are detected by the first and second position detection members. Since the failure state of the position detection members is determined based on an actual time difference and on a preset allowable range of time difference, the failure state can reliably be determined during the one operation of the lock bolt. As a result, it becomes possible to cope with the aftermath of the failure of the position detection members with expedition, and therefore it is possible to reliably prevent the lock bolt from becoming the inoperable state at the locked position and from making the automobile incapable of running.

### BRIEF DESCRIPTION OF THE DRAWINGS

The present invention will be further described with reference to the accompanying drawings wherein like reference numerals refer to like parts in the several views, and wherein:

FIG. 1 is a side cross-sectional view showing a steering lock device in a locked state according to an embodiment of the present invention;

FIG. 2 is a plan view showing the steering lock device of FIG. 1 without a cover;

FIG. 3A is an exploded perspective view showing a relationship among a cover, a rotating body and a rotor, while FIG. 3B is a perspective view showing an assembled state of the rotor and the rotating body;

FIG. 4 is a time chart showing a relationship among cam grooves of a lock bolt, the rotating body, the rotor and position detection members during unlocking operation;

FIG. 5 is a time chart showing a relationship among the cam grooves of the lock bolt, the rotating body, the rotor and the position detection members during locking operation;

FIG. 6 is a side cross-sectional view showing the steering lock device in an unlocked state;

FIG. 7 is a side cross-sectional view showing the lock bolt in a stopped state during locking operation;

FIG. 8 is a flowchart showing an unlocking processing by a microcomputer;

FIG. 9 is a flowchart subsequent to FIG. 8;

FIG. 10 is a flowchart showing a locking processing by a microcomputer;

FIG. 11 is a flowchart subsequent to FIG. 10;

FIG. 12 is a table showing failure detection patterns by the position detection members in the unlocking operation;

FIG. 13 is a table showing failure detection patterns by the position detection members in the locking operation; and

FIG. 14 is a table showing detectable/undetectable failure patterns in the conventional steering lock device.

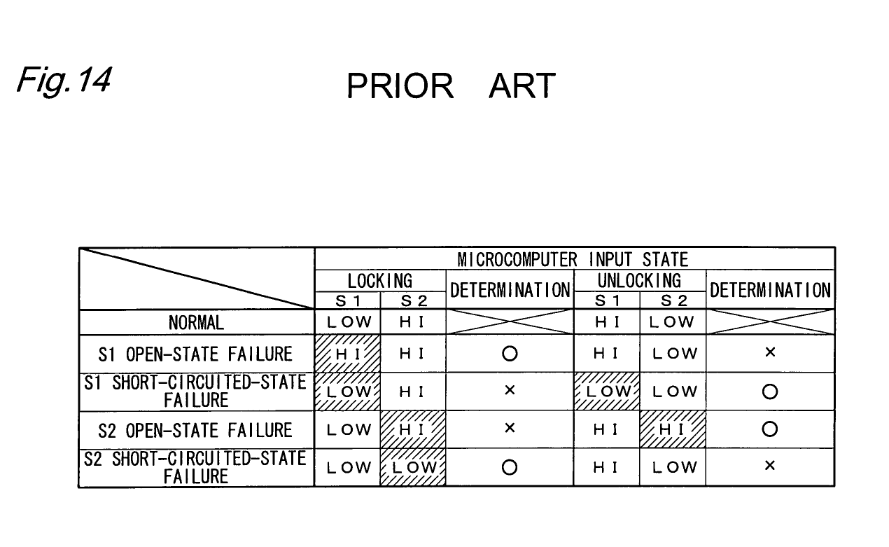

### DETAILED DESCRIPTION OF THE PREFERRED EMBODIMENTS

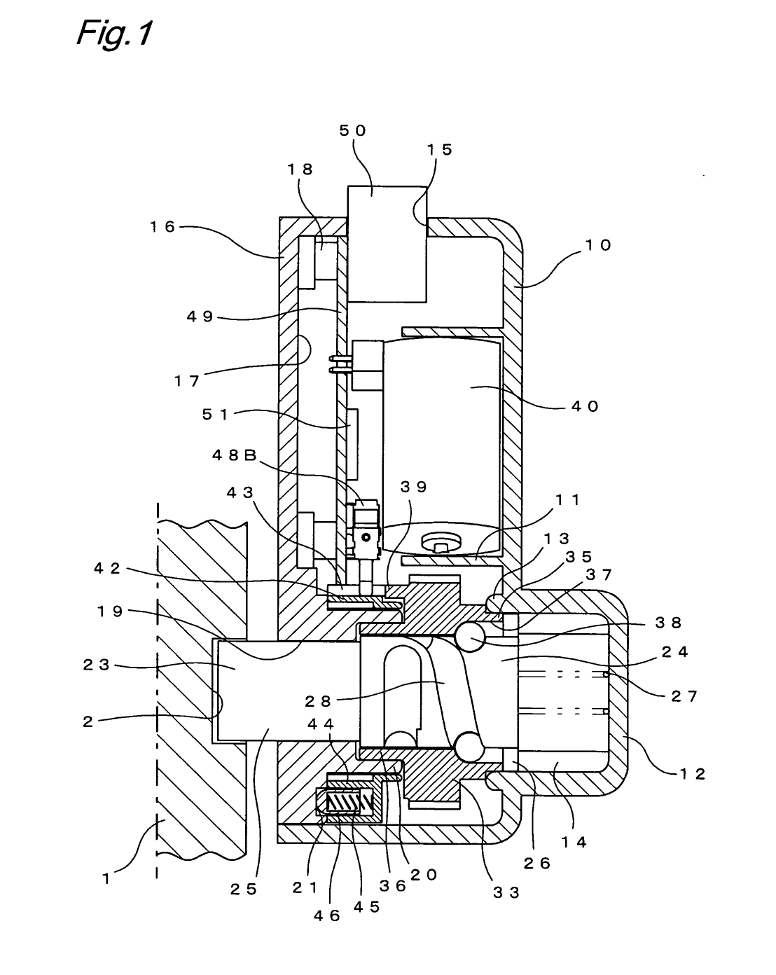

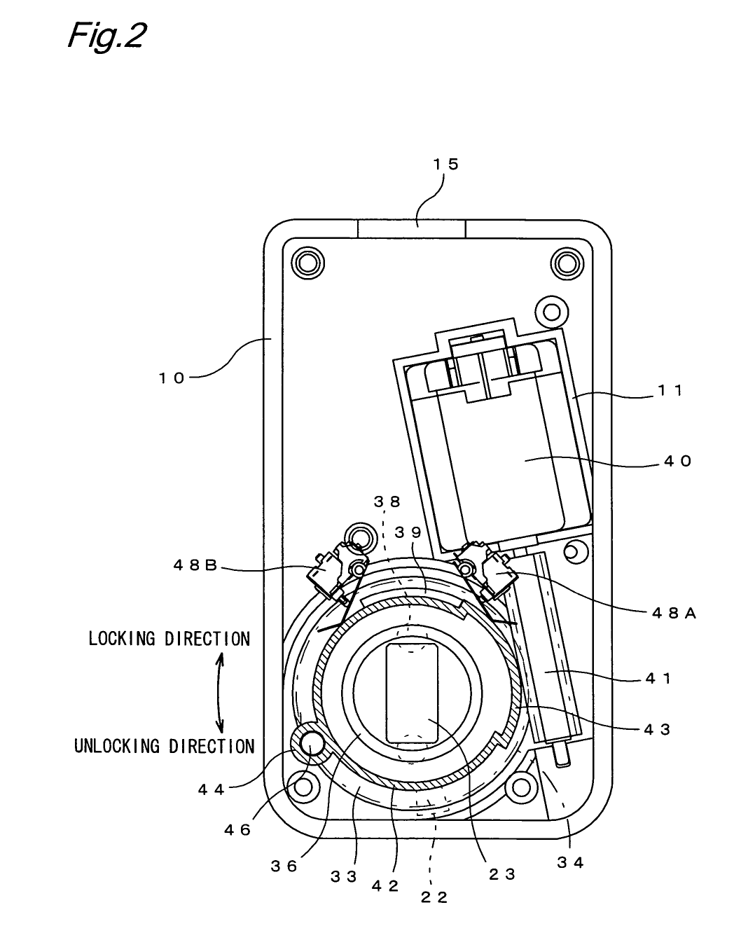

FIG. 1 and FIG. 2 show a steering lock device (hereinafter abbreviated to “lock device”) in an embodiment of the present invention. The lock device is provided around a steering shaft 1, which is a movable member that rotates along with rotating operation of an unshown steering, and operates in conjunction with key operation for starting or stopping an engine and the like. It is to be noted that the steering shaft 1 has an engagement recess section 2 formed thereon as with the conventional example.

The lock device in the present embodiment includes a casing composed of a case 10 opened at one end and a cover 16 for closing the opening of the case 10. Housed in the casing are a lock bolt 23 that can engage with the engagement recess section 2, a rotating body 33 for driving the lock bolt 23 forward and backward, an electric motor 40 as a drive unit for the rotor 33, a rotor 42 that operates in conjunction with rotation of the rotating body 33, detection switches 48A, 48B as a pair of position detection members, and a control board 49.

More specifically, as shown in FIG. 1 and FIG. 2, the case 10 has a fixed frame 11 for placing the electric motor 40 therein. Moreover, a bulge section 12 bulging outward in a generally circular shape is provided in a placement position of the rotor 42. A cylinder-shaped first positioning section 13 for positioning one end of the rotating body 33 is provided in a protruding manner on the edge of the opening portion of the bulge section 12. An engagement groove 14 extending in the axial direction for guiding the lock bolt 23 is provided on the inner circumferential face of the bulge section 12. Further, a notch section 15 for exposing a connector 50 mounted on the control board 49 is provided on a wall face at one end of the case 10.

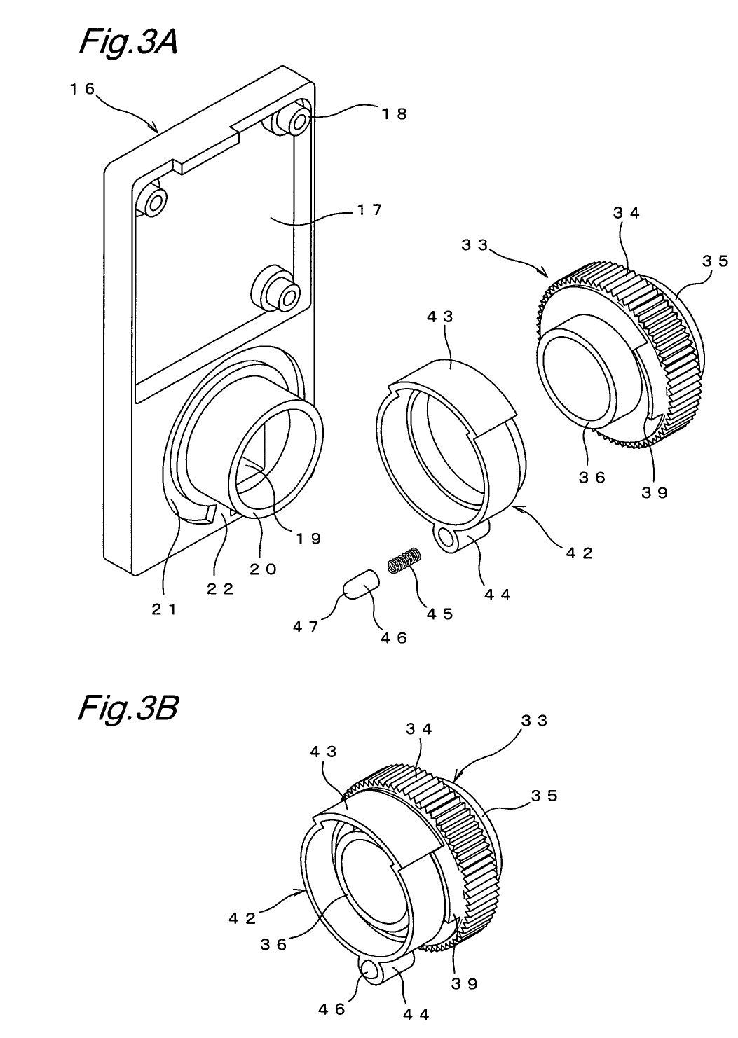

The cover 16 is fixed to the case 10 by a publicly-known engagement structure. As shown in FIG. 1 and FIG. 3A, the cover 16 has a recess section 17 formed in a region generally the half of one end of the cover 16 for placing the control board 49. Bosses 18 for fixing the control board 49 are provided at three corners of a rectangular bottom face of the recess section 17. The cover 16 also has a generally rectangular-shaped through hole 19 provided in a region on the opposite side of the recess section 17 and a cylinder-shaped second positioning section 20 provided in a protruding manner around the through hole 19. Further, a sliding groove 21 hollowed like a recess in a C shape is provided around the second positioning section 20. A not-hollowed portion that does not form the sliding groove 21 constitutes an locking wall 22.

As shown in FIG. 1, the lock bolt 23, which is placed inside the later-described rotating body 33 movably along the axial direction, is composed of a column-shaped section 24 positioned in the rotating body 33 and a bar section 25 extending from the column-shaped section 24 and having a generally rectangular-shaped cross section. When the later-described rotating body 33 is rotated in a locking direction that is a clockwise direction in FIG. 2, the bar section 25 protrudes outward from the through hole 19 of the cover 16 and engages with the engagement recess section 2 of the steering shaft 1, by which the lock bolt 23 locks the steering shaft 1 and in turn the steering. Otherwise, when the rotating body 33 is rotated in an unlocking direction that is a counterclockwise direction in FIG. 2, the bar section 25 retreats into the through hole 19 and the engagement with the engagement recess section 2 of the steering shaft 1 is cancelled, by which the lock bolt 23 unlocks the steering shaft 1 and in turn the steering.

In the lock bolt 23, a pair of engagement protruding sections 26, which are guided by the engagement groove 14 in the case 10 in an engaged state, are provided in an outer circumferential portion at the rear end (i.e., the right-hand end in FIG. 1) of the column-shaped section 24. Further, a spring 27 as a biasing member for biasing toward the steering shaft 1 is placed in between the rear end of the lock bolt 23 and the case 10.

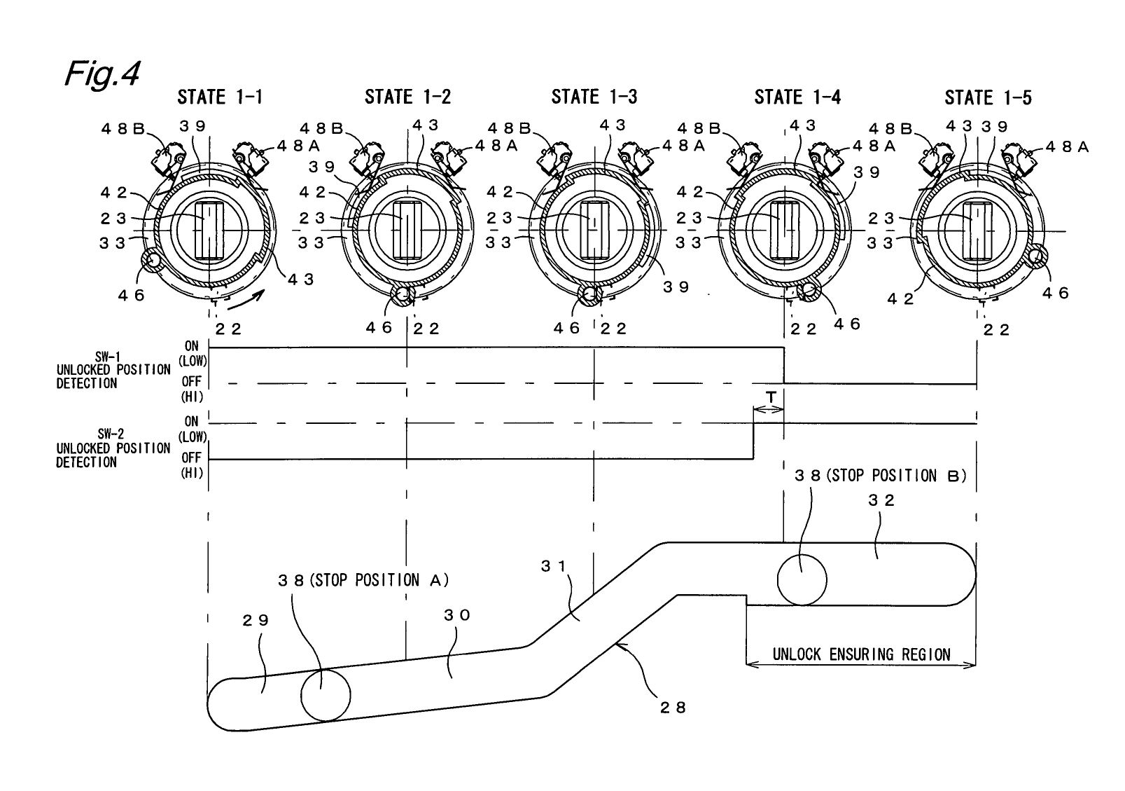

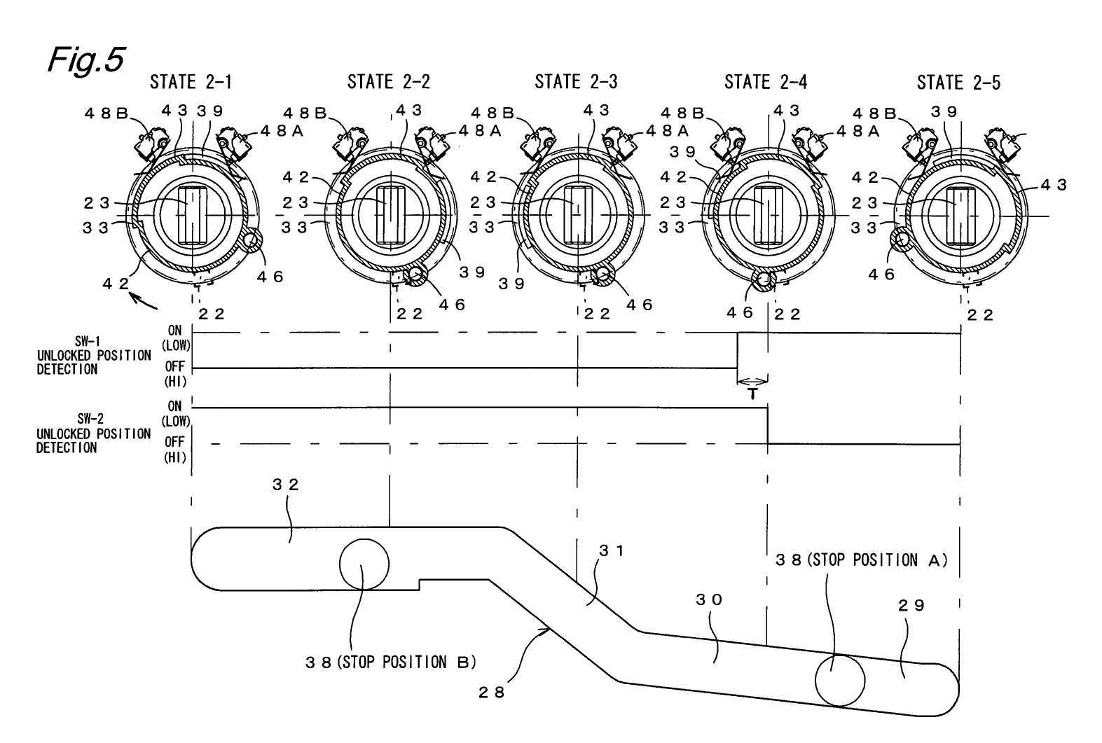

In the present embodiment, a pair of cam grooves 28 are formed at opposite positions on the outer circumferential face of the column-shaped section 24 so that the lock bolt 23 is not rotated with respect to the rotating body 33 but is moved in the axial direction. The transverse sections of these cam grooves 28 assume generally semicircular shapes, and later-described cam followers 38 are each held in the state of being fit in between the cam grooves 28 and a vertical groove 37 of the rotating body 33. More specifically, as shown in developed views in FIG. 4 and FIG. 5, the cam groove 28 is composed of a first extension section 29 extending in the circumferential direction, a gentle slope section 30 extending from the end of the first extension section 29 with a small angle of inclination, a steep slope section 31 extending from the end of the gentle slope section 30 with a large angle of inclination, and a second extension section 32 extending from the end of the steep slope section 31 in the circumferential direction. It is to be noted that in FIG. 4 and FIG. 5, the upper side corresponds to the side of the bar section 25 which is the top end of the lock bolt 23, while the lower side corresponds to the opposite side of the bar section 25 which is the rear end of the lock bolt 23.

Referring again to FIGS. 1-3, the rotating body 33, which is constituted of a worm wheel having a plurality of teeth 34 formed on its outer circumferential face portion, houses the lock bolt 23 in a movable manner in its inside and moves the lock bolt 23 in the axial direction through rotation by driving of the electric motor 40. The inner space of the rotating body 33 has a diameter slightly larger than that of the column-shaped section 24 of the lock bolt 23, and a first fitting section 35 that is to be fitted into the first positioning section 13 of the case 10 is provided on an opening edge at one end of the rotating body 33 while a second fitting section 36 that is to be fitted into the second positioning section 20 of the cover 16 is provided on an opening edge at the other end of the rotating body 33. By this, the rotating body 33 is interposed in between the first positioning section 13 of the case 10 and the second positioning section 20 of the cover 16, and therefore the rotating body 33 is held rotatably in the circumferential direction without moving in the axial direction. It is to be noted that the top end face of the first fitting section 35 has a step section formed for fitting the first positioning section 13.

In an inner circumferential section of the rotating body 33, a pair of vertical grooves 37 extending along the axial direction from the opening edge of the first fitting section 35 are provided at opposite positions. These vertical grooves 37, which assume generally semicircular shapes, are structured so that a pair of cam followers 38 made of spherical ball members are held in generally circular-shaped holding sections formed with the cam grooves 28 of the lock bolt 23. An engagement piece 39 is also provided in a protruding manner on the face of the rotating body 33 on the side of the second fitting section 36 for rotating a later-described rotor 42 in an interlocked state.

The electric motor 40, which has a terminal soldered to the control board 49 so as to have electric connection thereto, can rotate in both normal and reverse directions. An output shaft of the electric motor 40 is equipped with a worm 41 having teeth which are geared with the teeth 34 of the rotating body 33.

As shown in FIG. 1 to FIG. 3A, the rotor 42 is a cylinder-shaped rotor which is to be fitted to the outside of the second positioning section 20 of the cover 16, and a switch operation step section 43 bulging in steps in a specified angle range is provided on an outer circumferential section of the rotor 42. As shown in FIG. 3B, the switch operation step section 43 has an enough protruding amount so that the engagement piece 39 of the rotating body 33 can come into contact with both end faces in the circumferential direction of the switch operation step section 43. Therefore, when the rotating body 33 is rotated, the turning force is transmitted through the engagement piece 39 to the rotor 42. Provided at a position on the rotor 42 which corresponds to the sliding groove 21 of the cover 16 is a housing section 44 assuming a cylinder shape with one end being closed. In the housing section 44, a spring 45 as a biasing member and a sliding pin 46 with a hemispherical head are received. It is to be noted that the range of angles at which the switch operation step section 43 bulges as well as the formation positions of the switch operation step section 43 and the housing section 44 are set depending on their correlation with later-described detection switches 48A, 48B. Moreover, the radius of a hemispherical section 47 at the head of the sliding pin 46 is set to be larger than the depth of the sliding groove 21 on the cover 16, i.e., the height of the locking wall 22.

The first and second detection switches 48A, 48B are micro switches which are turned on by pressing of a detection lever, and the pressing operation is performed by the outer circumferential face of the switch operation step section 43 in the rotor 42. More specifically, in the locked state shown in FIG. 2, the first detection switch 48A positioned on the right side is in ON state, and the second detection switch 48B positioned on the left side is in OFF state. Otherwise, in the unlocked state, the first detection switch 48A is in OFF state and the second detection switch 48B is in ON state. These detection switches 48A, 48B respectively output LOW signals in ON state and output HI signals in OFF state. Consequently, the detection switches 48A, 48B respectively output LOW and HI signals in the locked state and respectively output HI and LOW signals in the unlocked state. In the present embodiment, the positions of the detection switches 48A, 48B and the circumferential sizes of and the switch operation step section 43 are so set that a time difference is generated between detection time points (operation time points) of the detection switches 48A, 48B which are turned on/off by the switch operation step section 43 in the rotor 42.

The electric motor 40, a connector 50 for inputting electric power and control signals, and a microcomputer 51 as a control member are mounted on the control board 49. The normal and reverse rotations of the electric motor 40 are controlled based on a program stored in a ROM that is a storage member incorporated in the microcomputer 51. The microcomputer 51 in the present embodiment also functions as a position determination member for determining the operation state of the lock bolt 23 based on input signals inputted into ports connected to the detection switches 48A, 48B. The microcomputer 51 also functions as a failure determination member for determining the presence of a failure of the first detection switch 48A or the second detection switch 48B based on an actual detection time difference between the detection switches 48A, 48B and on a preset allowable range of the time difference.

Moreover, when the microcomputer 51 determines that the first detection switch 48A or the second detection switch 48B has a failure, the microcomputer 51 prohibits a subsequent shifting operation to the locked state of the lock bolt 23. More specifically, when it is determined that the first detection switch 48A or the second detection switch 48B has a failure during a shifting operation of the lock bolt 23 from the locked state to the unlocked state, the microcomputer 51 prohibits a shifting operation to the locked state after the completion of an unlocking operation. Moreover, when it is determined that the first detection switch 48A or the second detection switch 48B has a failure at the start of a shifting operation of the lock bolt from the unlocked state to the locked state, the microcomputer 51 prohibits the shifting operation to the locked state. Here, “at start” means a time when a steering locking processing by the microcomputer 51 has already started and when an actual shifting operation of the lock bolt from the unlocked state to the locked state has not yet started. Further, when it is determined that the first detection switch 48A or the second detection switch 48B has a failure after the start of the actual shifting operation of the lock bolt from the unlocked state to the locked state, the microcomputer 51 prohibits a next shifting operation to the locked state once the shifting operation to the locked state is completed and then a shifting operation to the unlocked state is completed.

Description is now given of the locking operation and the unlocking operation by the lock device.

In order to shift the lock bolt 23 from the locked state to the unlocked state, the electric motor 40 is driven in the normal direction in the locked state shown in FIG. 1. Consequently, as shown in FIG. 4, the rotating body 33 is rotated counterclockwise via the worm 41, and the cam follower 38 positioned in the vicinity of a motor stop position A moves while sliding or rotating in the cam groove 28. However, since the cam follower 38 positions in the vertical groove 37 in the rotating body 33 and therefore cannot moves forward (i.e., on the steering shaft 1 side) nor in the circumferential direction, the lock bolt 23 starts to move backward (i.e., on the opposite side to the steering shaft 1) by the rotation of the rotating body 33.

It is to be noted that when the cam follower 38 moves along the gentle slope section 30 of the cam groove 28, the lock bolt 23 retreats from the locked position relatively slowly. By this, a pulling load generated when the top end of the lock bolt 23 is pulled from the engagement recess section 2 of the steering shaft 1 can be increased. Because of this, even if a torque is exerted on the steering shaft 1 and the inner face of the engagement recess section 2 is in pressure contact with the top end of the lock bolt 23, the lock bolt 23 can surely be pulled away from the engagement recess section 2. Moreover, it becomes possible to eliminate reduction gears and the like for increasing the pulling load and it also becomes possible to downsize the electric motor 40. As a result, downsizing of the entire lock device can be achieved.

Subsequently, when the cam follower 38 continues to move to a motor stop position B through the steep slope section 31 of the cam groove 28 according to the rotation of the rotating body 33, the lock bolt 23 retreats relatively fast. Thus, increasing the operation speed of the lock bolt 23 after the top end is pulled away from the engagement recess section 2 of the steering shaft 1 can shorten the operation time of the motor 40. Further, it is also possible to shorten a time taken to start the engine after the steering lock is unlocked, and thereby the convenience for users can be enhanced.

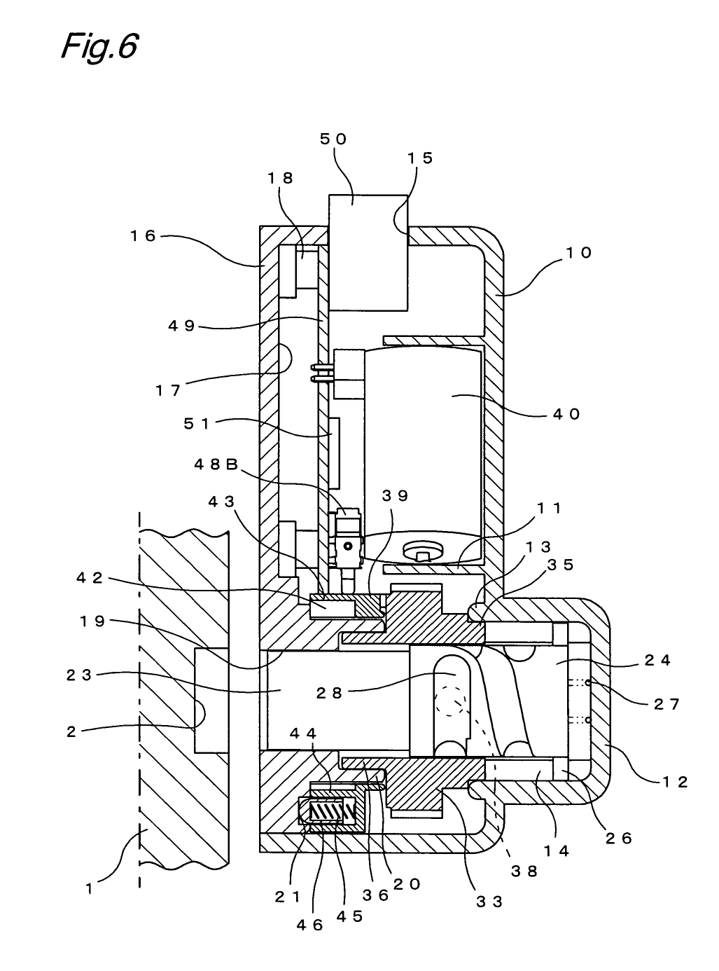

Thus, the shift of the lock bolt 23 from the locked position to the unlocked position releases the engagement of the lock bolt 23 with the engagement recess section 2 of the steering shaft 1 as shown in FIG. 6, and thereby rotation regulation of the steering shaft 1 is cancelled, by which the steering is put in the unlocked state.

Conversely, in order to shift the lock bolt 23 from the unlocked state to the locked state, the electric motor 40 is driven in the reverse direction in the unlocked state shown in FIG. 6. Consequently, as shown in FIG. 5, the rotating body 33 is rotated clockwise via the worm 41, and the cam follower 38 in the vicinity of the motor stop position B moves to the motor stop position A through the cam groove 28. By this, the lock bolt 23 advances from the unlocked position toward the locked position shown in FIG. 1 with biasing force by the spring 27. As a result, the lock bolt 23 goes into and engages with the engagement recess section 2 of the steering shaft 1, and the steering shaft 1 is subjected to the rotation regulation, by which the steering is put in the locked state.

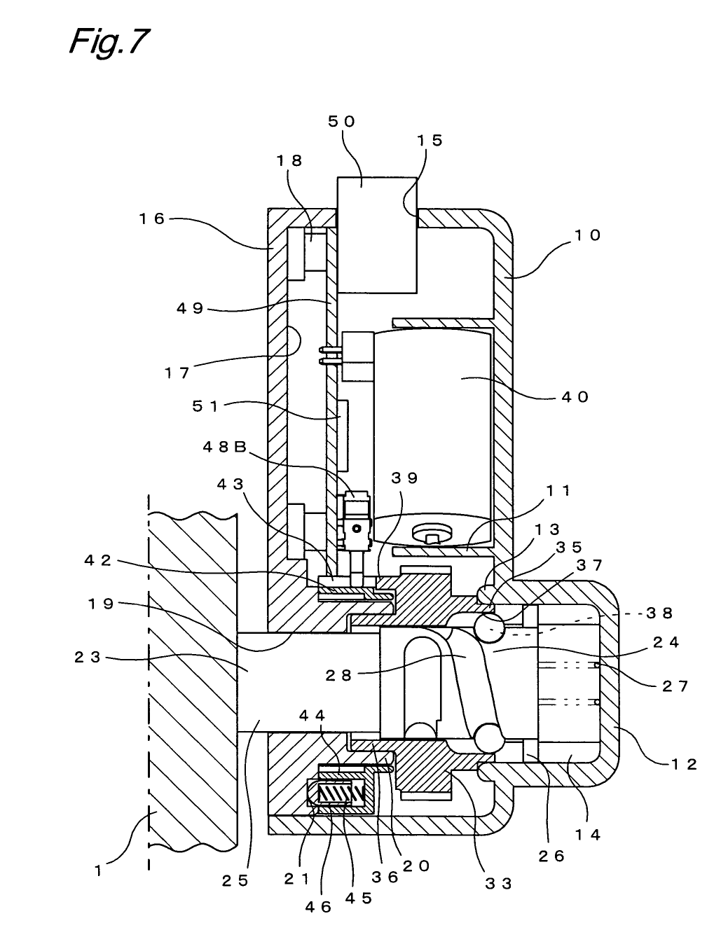

In this case, as shown in FIG. 7, the engagement recess section 2 of the steering shaft 1 is often out of alignment with the lock bolt 23. In such a case, the lock bolt 23 cannot go into the engagement recess section 2 and so the locked state shown in FIG. 1 cannot be achieved. However, when the steering shaft 1 is rotated in this state and the lock bolt 23 thereby aligns with the engagement recess section 2, the lock bolt 23 can go into the engagement recess section 2 by biasing force of the spring 27 so that the locked state shown in FIG. 1 can be achieved.

More specifically, in the case where a locking operation is performed in the state that the engagement recess section 2 is out of alignment with the lock bolt 23, the lock bolt 23 advanced by the rotation of the rotating body 33 stops along the way in the state of being in contact with the outer circumferential face of the steering shaft 1. When the rotating body 33 is further rotated in this state, the cam followers 38 can move backward along the vertical grooves 37 on the rotating body 33, and therefore the rotating body 33 is rotated to the normal locked position without hindering rotation of the rotating body 33 and the electric motor 40. Then, once the engagement recess section 2 aligns with the lock bolt 23, the lock bolt 23 goes into the engagement recess section 2 by biasing force of the spring 27, by which the locked state is achieved.

It is to be noted that in the locking operation and the unlocking operation by rotation of the rotating body 33, even if driving of the electric motor 40 is stopped when the cam followers 38 have just reached the motor stop positions A, B, the electric motor 40 and the rotating body 33 sometimes inertially rotate and fail to stop immediately. However, in this embodiment, the extension sections 29, 32 are provided on both ends of the slope sections 30, 31, and therefore the cam follower 38 going into the extension sections 29, 32 can prevent urgent stop of the electric motor 40. As a result, it becomes possible to prevent an excessive load exerted on the electric motor 40 and it also becomes possible to set the motor stop positions in a mildly limited range including error margin. Here, it is, naturally, to be noted that since the extension sections 29, 32 extend in the circumferential direction of the column-shaped section 24, the lock bolt 23 does not move when the cam followers 38 move.

In the thus-structured lock device, since the lock bolt 23 is placed inside thereof and the lock bolt 23 is operated by the rotating body 33 which rotates around the shaft that extends in the moving direction of the lock bolt 23, the overall downsizing can be achieved. Moreover, since the cam grooves 28 are formed on the outer circumferential face of the lock bolt 23, formation of the cam grooves 28 is facilitated. Further, since two sets of the cam groove 28 and the cam follower 38 are provided, the lock bolt 23 can be operated with less shaking than the case of providing single set of the cam groove and the cam follower. Furthermore, the lock bolt 23 is operated via the cam followers 38 made of spherical ball members, and this makes it possible to prevent wear of the cam grooves 28 and generation of abnormal noise as well as to decrease resistance when the cam followers 38 move in the cam grooves 28.

Description is now given of the interlocking operation of the rotating body 33 and the rotor 42 accompanied with the locking operation and the unlocking operation, as well as the turn-on/turn-off operations of the detection switches 48A, 48B by the rotor 42.

As shown in FIG. 4, in a locked state in a state 1-1, the first detection switch 48A is in ON state and the second detection switch 48B is in OFF state. When the microcomputer 51 executes the unlocking operation, i.e., drives the electric motor 40 in the normal direction so as to rotate the rotating body 33 counterclockwise, the rotor 42 co-rotates counterclockwise in conjunction with the rotation of the rotating body 33 by friction between the rotating body 33 and the rotor 42. The rotation of the rotor 42 stops at the point of time when the sliding pin 46 moves along the sliding groove 21 and comes into contact with the locking wall 22 at one end of the sliding groove 21 as shown in a state 1-2. It is to be noted that in the state 1-2, the ON state of the first detection switch 48A and the OFF state of the second detection switch 48B are maintained.

After the co-rotation of the rotor 42 by the friction is stopped, only the rotating body 33 rotates and the engagement piece 39 of the rotating body 33 reaches one end of the switch operation step section 43 as shown in a state 1-3. In this state, the rotor 42 does not rotate, and therefore it is maintained that the first detection switch 48A is in ON state and the second detection switch 48B is in OFF state.

Then, when the rotating body 33 rotates, the engagement piece 39 presses the switch operation step section 43 as shown in a state 1-4. Consequently, the sliding pin 46 retreats into the housing section 44 against the biasing force of the spring 45 and goes over the locking wall 22. In this case, first, the second detection switch 48B comes to position within the region of the switch operation step section 43 and thereby comes into the ON state. Then, the first detection switch 48A goes out of the region of the switch operation step section 43 and thereby comes into the OFF state. After that, when the electric motor 40 and the rotating body 33 inertially rotate, the state shown in a state 1-5 is attained. It is to be noted that in this state, the OFF state of the first detection switch 48A and the ON state of the second detection switch 48B are maintained.

Contrary to the above, as shown in FIG. 5, in the unlocked state in a state 2-1, the first detection switch 48A is in OFF state and the second detection switch 48B is in ON state as described before. When the microcomputer 51 executes the locking operation, i.e., drives the electric motor 40 in the reverse direction so as to rotate the rotating body 33 clockwise, the rotor 42 co-rotates clockwise in conjunction with the rotation of the rotating body 33 by friction therebetween. The rotation of the rotor 42 stops at the point of time when the sliding pin 46 comes into contact with the locking wall 22 at the end of the sliding groove 21 as shown in a state 2-2. It is to be noted that in the state 2-2, the OFF state of the first detection switch 48A and the ON state of the second detection switch 48B are maintained.

After the co-rotation of the rotor 42 by the friction is stopped, only the rotating body 33 rotates and the engagement piece 39 of the rotating body 33 reaches the end of the switch operation step section 43 as shown in a state 2-3. In this state, the rotor 42 does not rotate, and therefore it is maintained that the first detection switch 48A is in OFF state and the second detection switch 48B is in ON state.

Then, when the rotating body 33 rotates, the engagement piece 39 presses the switch operation step section 43 as shown in a state 2-4. Consequently, the sliding pin 46 goes over the locking wall 22 and rotates. As a result, first, the first detection switch 48A comes to position within the region of the switch operation step section 43 and thereby comes into the ON state. Then, the second detection switch 48B goes out of the region of the switch operation step section 43 and thereby comes into the OFF state. After that, when the electric motor 40 and the rotating body 33 inertially rotate, the state shown in a state 2-5 is attained. It is to be noted that in this state, the ON state of the first detection switch 48A and the OFF state of the second detection switch 48B are maintained.

Thus, in the present invention, the positions of the detection switches 48A, 48B and the circumferential size of the switch operation step section 43 are so set as to generate a time difference T between detection time points by the first and second detection switches 48A, 48B. In the present embodiment, the detection time difference T is set at approx. 10 msec. Therefore, an allowable range (approx. ±5 msec) of the time difference in consideration of operation error is preset, and if an actual time difference is out of this range, the microcomputer 51 determines that either the detection switch 48A or 48B has a failure during the operation. That is, if a signal change based on the turn-on/turn-off operation of one of the detection switches 48A, 48B is detected and then a signal change of the other detection switch 48A or 48B is detected at a time point less than or beyond the allowable range of the time difference range, then it can be determined that either the detection switch 48A or 48B has a failure.

Next, the control by the microcomputer 51 will be described in concrete terms. It is to be noted that in the following flowchart, a flag Fa denotes whether or not abnormal conditions are detected at the start of operation in unlocking processing, a flag Fb denotes whether or not abnormal conditions are detected during operation in the unlocking processing, a flag Fc denotes whether or not abnormal conditions are detected at the end of operation in the unlocking processing, a flag Fd denotes whether or not abnormal conditions are detected at the start of operation in locking processing, a flag Fe denotes whether or not abnormal conditions are detected during operation in the locking processing, and a flag Ff denotes whether or not abnormal conditions are detected at the end of operation in the locking processing. In the flags Fa to Ff, a numerical value “1” signifies that abnormal conditions are detected and a numerical value “0” signifies that abnormal conditions are not detected. A first set time is used in a safety timer for the case where both the detection switches 48A, 48B have failures without signal changes (in the state that abnormal conditions are undetectable), and a second set time is used in a safety timer for the case where a signal change of either the detection switch 48A or 48B is detected and then a failure occurs in the state that abnormal conditions are undetectable.

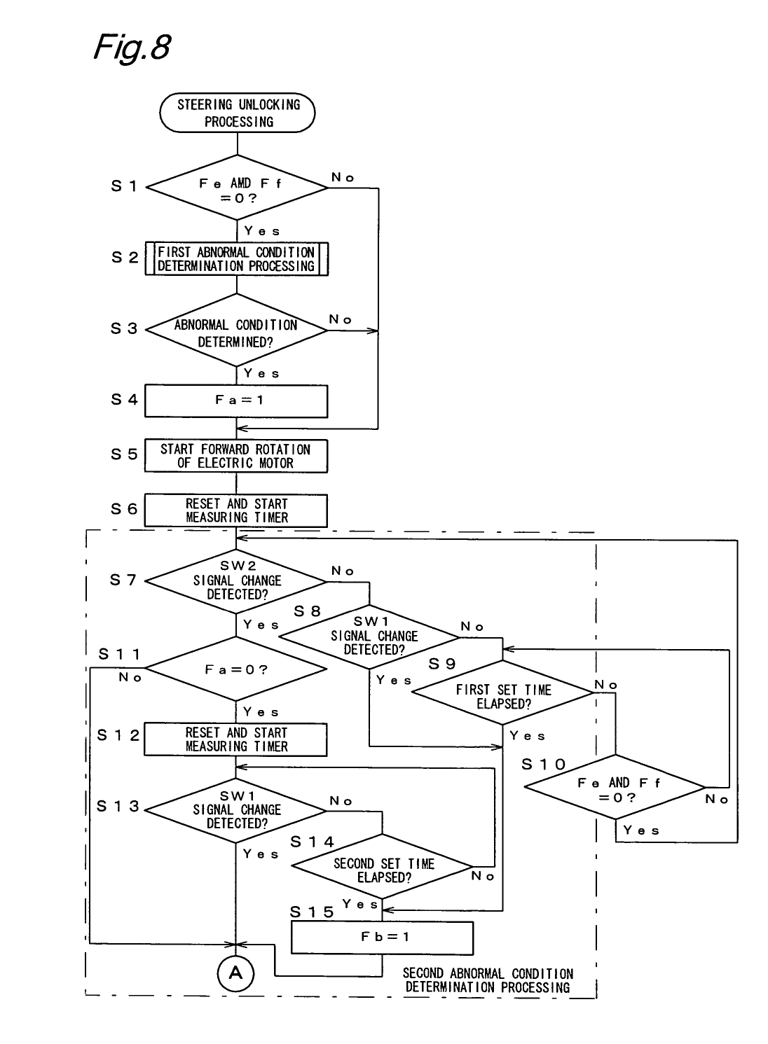

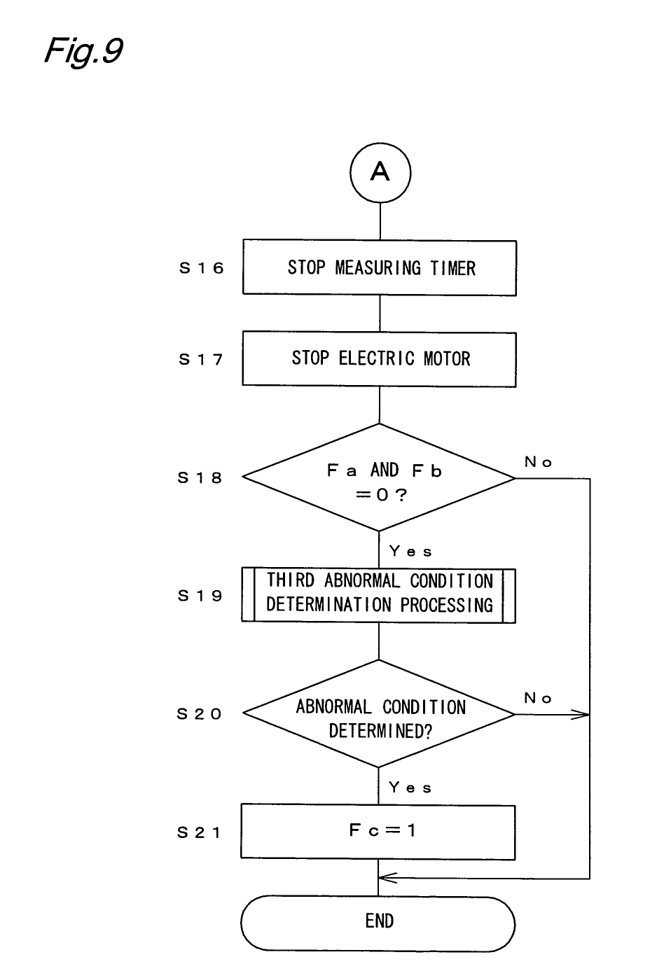

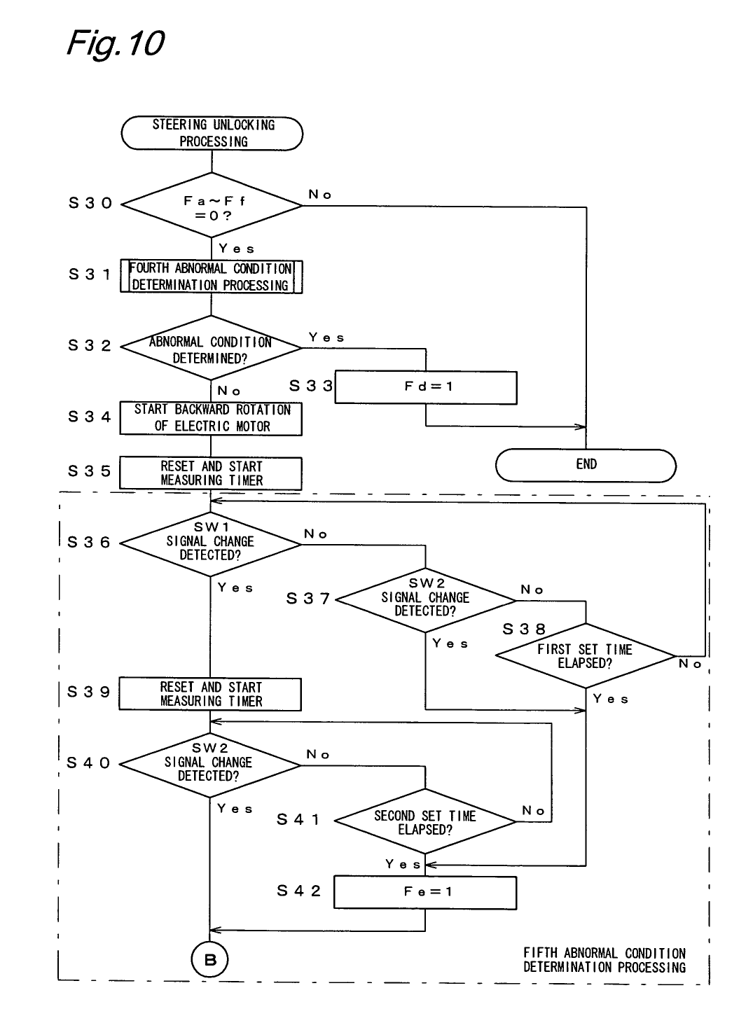

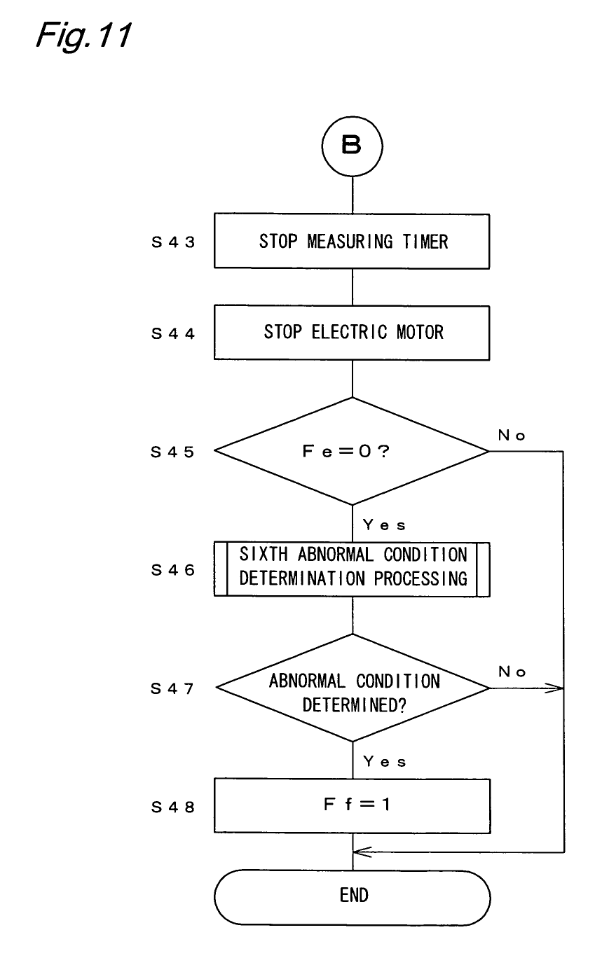

Upon reception of an unlocking operation instruction or a locking operation instruction via the connector 50, the microcomputer 51 executes an unlocking processing shown in FIG. 8 and FIG. 9 or a locking processing shown in FIG. 10 and FIG. 11. Alternatively, upon reception of an operation instruction via the connector 50, the microcomputer 51 checks a present operation position, and execute an unlocking processing in the case of the locked state, or executes a locking processing in the case of the unlocked state.

In the steering unlocking processing, first, in step S1, the microcomputer 51 determines whether or not both Fe and Ff are “0” in order to detect whether or not the failure of either the detection switch 48A or 48B has been detected after the start of the previous locking processing as shown in FIG. 8. If both the flags Fe and Ff are “0”, that is, if the failures of the detection switches 48A, 48B are not detected, then the process proceeds to step S2. If any one of the flags Fe and Ff is not “0”, that is, if the failure of either the detection switch 48A or 48B is detected, then the process proceeds to step S5.

In step S2, a first abnormal condition determination processing is executed. In the first abnormal condition determination processing, the ports connected to the detection switches 48A, 48B are read and the presence of abnormal conditions is determined by whether or not the signals in the ports are input signals (LOW, HI) inputted from the detection switches 48A, 48B in the normal locked state.

In step S3, if abnormal conditions are determined in the first abnormal condition determination processing, then the process proceeds to step S4, where the flag Fa is set to a numerical value “1” so as to register that abnormal conditions have been detected at the start of operation in the unlocking processing, and the process proceeds to step S5. If abnormal conditions are not determined in the first abnormal condition determination processing, then the process proceeds to step S5 without any processing.

In step S5, normal driving of the electric motor 40 is started and then in step S6, a measuring timer in the stopped state is reset and started. Then, in step S7, the presence of a signal change caused by turn-off of the second detection switch 48B is determined. If the signal change of the second detection switch 48B is not detected, then the process proceeds to step S8, whereas if the signal change is detected, then the process proceeds to step S11.

In step S8, the presence of a signal change caused by turn-off of the first detection switch 48A is determined. If the signal change of the first detection switch 48A is not detected, then the process proceeds to step S9. If the signal change is not detected, that is, if the signal change of the first detection switch 48A is detected first regardless of the structure that the second detection switch 48B should have a signal change first, then it is determined that abnormal conditions have occurred either in the detection switch 48A or 48B and the process proceeds to step S15, where the flag Fb is set to a numerical value “1” so as to register that abnormal conditions have been detected during operation in the unlocking processing, and the process proceeds to step S16 shown in FIG. 9. It is to be noted that a delay timer for ensuring completion of the unlocking operation may be placed in between step S8 and step S15.

In step S9, it is determined, based on a measured time by the measuring timer, whether or not the first set time that ensures completion of the unlocking operation has elapsed. If the first set time has not elapsed, then the process proceeds to step S10, whereas if the first set time has elapsed, then the process proceeds to step S15, where the flab Fb is set to a numerical value “1” and the process proceeds to step S16 shown in FIG. 9.

In step S10, it is determined whether or not both the flags Fe and Ff, which denote whether or not abnormal conditions are detected after the start of the previous locking processing, are “0”. If both the flags are “0”, then the process returns to step S7, whereas if any one of the flags Fe and Ff is not “0”, then the process returns to step S9, and at the conclusion of the first set time, the process proceeds to step S15.

If the signal change of the second detection switch 48B is detected in step S7, then it is determined in step S11 that the flag Fa is set to a numerical value “0” in order to detect whether or not abnormal conditions have been determined in the first abnormal condition determination processing. If the flag Fa is “0” (i.e., abnormal conditions not determined), then the process proceeds to step S12, whereas if the flag Fa is “1” (i.e., abnormal conditions determined), then the process proceeds to step S16 shown in FIG. 9. It is to be noted that a delay timer for ensuring completion of the unlocking operation may be placed in between step S11 and step S16.

In step S12, the measuring timer during measurement is reset and started, and then in step S13, the presence of a signal change of the first detection switch 48A is determined. If the signal change of the first detection switch 48A is detected, then the process proceeds to step S16 shown in FIG. 9, whereas if the signal change of the first detection switch 48A is not detected, the process proceeds to the step S14.

In the step S14, it is determined, based on a measured time by the measuring timer, whether or not the second set time that ensures completion of the unlocking operation after detection of the signal change of the second detection switch 48B has elapsed. If the second set time has not elapsed, then the process returns to step S13, whereas if the second set time has elapsed, then the process proceeds to step S15, where the flag Fb is set to a numerical value “1” and the process proceeds to step S16 shown in FIG. 9.

It can be said that the process from step S7 to step S15 except the step S10, S11 functions as a second abnormal condition determination processing for determining the presence of abnormal conditions in the detection switches 48A, 48B based on the order of signal changes of the detection switches 48A, 48B and on the presence of the signal changes in the unlocking processing.

When the unlocking operation is credibly completed by the above control, the measuring timer during measurement is stopped in step S16 and the electric motor 40 is stopped in step S17 as shown in FIG. 9.

Then, in step S18, it is determined whether or not both the flags Fa and Fb are “0” in order to determine whether or not abnormal conditions have been detected during this unlocking operation. If both the flags are “0”, that is, if the abnormal conditions of the detection switches 48A, 48B are not detected in this unlocking operation, then the process proceeds to step S19. If any one of the flags Fa and Fb is not “0”, that is, if the abnormal conditions of either the detection switch 48A or 48B are detected, then the steering unlocking processing is ended without further processing.

In step S19, a third abnormal condition determination processing is executed. In the third abnormal condition determination processing as with the first abnormal condition determination processing, the ports connected to the detection switches 48A, 48B are read and the presence of abnormal conditions is determined by whether or not the signals in the ports are input signals (HI, LOW) inputted from the detection switches 48A, 48B in the normal unlocked state. Further, based on an actual detection time difference from the signal change of the second detection switch 48B to the signal change of the first detection switch 48A (step S12 to S16) and on a preset allowable range of the time difference, the presence of a failure in the first detection switch 48A or the second detection switch 48B is determined. More specifically, when abnormal conditions occur in the first detection switch 48A, an actual detection time difference often becomes shorter or longer than the normal time difference T. Therefore, the allowable range of the time difference in consideration of the operation error is collated with an actual detection time difference, and if the actual detection time difference is out of the allowable range of the time difference, then it is determined that abnormal conditions have occurred, whereas if the actual detection time difference is within the allowable range of the time difference, then it is determined that abnormal conditions have not occurred.

Subsequently, in step S20, if abnormal conditions are determined by the third abnormal condition determination processing, the process proceeds to step S21, where the flag Fc is set to a numerical value “1” so as to register that abnormal conditions have been detected at the end of operation in the unlocking processing, and the steering unlocking processing is ended. If abnormal conditions are not determined by the third abnormal condition determination processing, then the steering unlocking processing is ended without further processing.

Next, in the steering locking processing, as shown in FIG. 10, first, in step S30, the microcomputer 51 determines whether or not all the flags Fa to Ff are “0” in order to detect whether or not a failure of either the detection switch 48A or 48B has been detected after execution of the previous locking processing and unlocking processing. If all the flags are “0”, that is, if the failures of the detection switches 48A, 48B are not detected, then the process proceeds to step S31. If any one of the flags Fa to Ff is not “0”, that is, if a failure of either the detection switch 48A or 48B is detected, then the locking processing is ended without any processing.

In step S31, a fourth abnormal condition determination processing is executed. In the fourth abnormal condition determination processing as with the first abnormal condition determination processing, the ports connected to the detection switches 48A, 48B are read and the presence of abnormal conditions is determined by whether or not the signals in the ports are input signals (HI, LOW) inputted from the detection switches 48A, 48B in the normal unlocked state.

Subsequently, in step S32, if abnormal conditions are determined by the fourth abnormal condition determination processing, the process proceeds to step S33, where the flag Fd is set to a numerical value “1” so as to register that abnormal conditions have been detected at the start of operation in the locking processing, and the lock processing is ended without further processing. If abnormal conditions are not determined by the fourth abnormal condition determination processing, then the process proceeds to step S34.

In step S34, reverse driving of the electric motor 40 is started and then in step S35, the measuring timer in the stopped state is reset and started. Then, in step S36, the presence of a signal change caused by turn-on of the first detection switch 48A is determined. If the signal change of the first detection switch 48A is not detected, then the process proceeds to step S37, whereas if the signal change is detected, then the process proceeds to step S39.

In step S37, the presence of a signal change caused by turn-off of the second detection switch 48B is determined. If the signal change of the second detection switch 48B is not detected, then the process proceeds to step S38. If the signal change is detected, that is, if the signal change of the second detection switch 48B is detected first regardless of the structure that the first detection switch 48A should have a signal change first, then it is determined that abnormal conditions have occurred either in the detection switch 48A or 48B and the process proceeds to step S42, where the flag is set to a numerical value “1” so as to register that abnormal conditions have been detected during operation in the locking processing, and the process proceeds to step S43 shown in FIG. 11. It is to be noted that a delay timer for ensuring completion of the locking operation may be placed in between step S37 and step S42.

In step S38, it is determined based on a measured time by the measuring timer whether or not the first set time that ensures completion of the locking operation has elapsed. If the first set time has not elapsed, then the process returns to step S36, whereas if the first set time has elapsed, then the process proceeds to step S42, where the flag Fe is set to a numerical value “1” and the process proceeds to step S43 shown in FIG. 11.

Contrary to the above, if the signal change of the first detection switch 48A is detected in step S36, the measuring timer during measurement is reset and started in step S39, and then in step S40, the presence of a signal change of the second detection switch 48B is determined. If the signal change of the second detection switch 48B is detected, then the process proceeds to step S43 shown in FIG. 11, whereas if the signal change of the second detection switch 48B is not detected, then the process proceeds to the step S41.

In the step S41, it is determined, based on a measured time by the measuring timer, whether or not the second set time that ensures completion of the locking operation after detection of the signal change of the first detection switch 48A has elapsed. If the second set time has not elapsed, then the process returns to step S40, whereas if the second set time has elapsed, then the process proceeds to step S42, where the flag Fe is set to a numerical value “1” and the process proceeds to step S43 shown in FIG. 11.

It can be said that the process from step S36 to step S42 functions as a fifth abnormal condition determination processing for determining the presence of abnormal conditions in the detection switches 48A, 48B based on the order of signal changes of the detection switches 48A, 48B and on the presence of the signal changes in the locking processing.

When the locking operation is credibly completed by the above control, the measuring timer during measurement is stopped in step S43 and the electric motor 40 is stopped in step S44 as shown in FIG. 11.

Then, in step S45, it is determined whether or not the flag Fe is “0” in order to determine whether or not abnormal conditions have been detected during this locking operation. If the flag Fe is “0”, that is, if the abnormal conditions of the detection switches 48A, 48B are not detected in this locking operation, then the process proceeds to step S46. If the flag Fe is not “0”, that is, if the abnormal conditions of either the detection switch 48A or 48B are detected, then the steering unlocking processing is ended without further processing.

In step S46, a sixth abnormal condition determination processing is executed. In the sixth abnormal condition determination processing as with the third abnormal condition determination processing, the ports connected to the detection switches 48A, 48B are read and the presence of abnormal conditions is determined by whether or not the signals in the ports are input signals (LOW, HI) inputted from the detection switches 48A, 48B in the normal locked state. Further, based on an actual detection time difference from the signal change of the first detection switch 48A to the signal change of the second detection switch 48B (step S39 to S43) and on a preset allowable range of the time difference, the presence of abnormal conditions in the first detection switch 48A or the second detection switch 48B is determined.

Subsequently, in step S47, if abnormal conditions are determined by the sixth abnormal condition determination processing, the process proceeds to step S48, where the flag Ff is set to a numerical value “1” so as to register that abnormal conditions have been detected at the end of operation in the locking processing, and the steering locking processing is ended. If abnormal conditions are not determined by the sixth abnormal condition determination processing, then the steering locking processing is ended without further processing.

Thus, in the lock device according to the present invention, two detection switches 48A, 48B allow reliable determination of the locked state or the unlocked state of the lock bolt 23. In addition, the first and second detection switches 48A, 48B are so placed that their detection time points are different from each other so as to generate a detection time difference. Since the presence of failures of the detection switches 48A, 48B is determined based on the actual time difference and a preset allowable range of the time difference, occurrence of the switch failure can reliably be determined during the one operation. As a result, it becomes possible to cope with the aftermath of the failure with expedition.

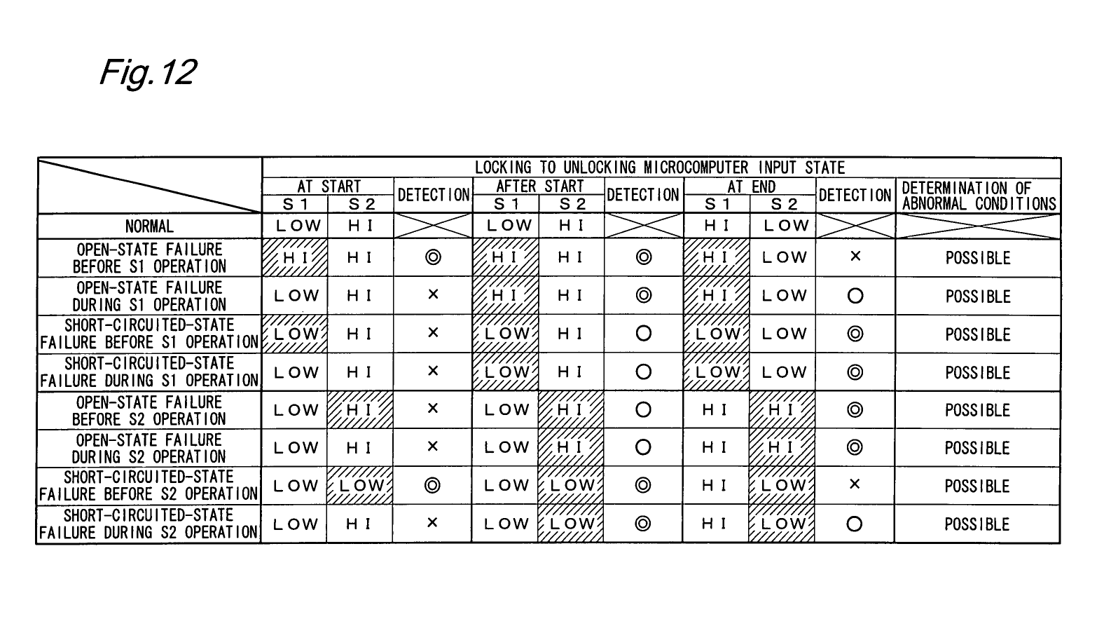

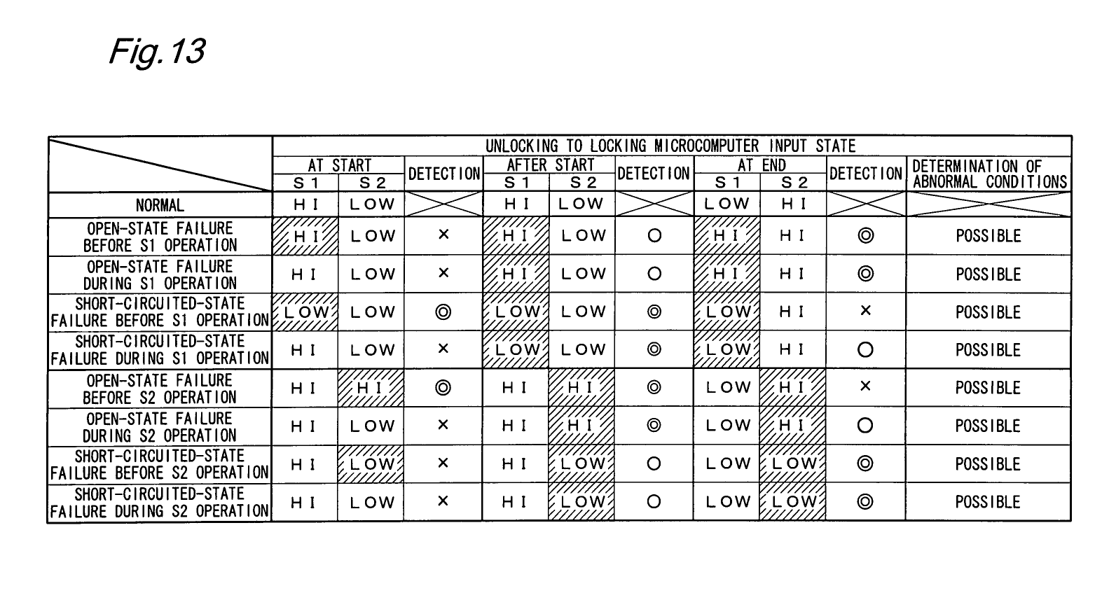

More specifically, in the case where the first detection switch 48A (shown by “S1” in FIGS. 12 and 13) already has a failure in an open (cut-off) state at the start of the unlocking operation as shown in FIG. 12, the abnormal condition can be detected by the first abnormal condition determination processing executed at the start of the operation and by the second abnormal condition determination processing executed after the start of the operation Moreover, in the case where the first detection switch 48A fails in the open state after the start of operation, the abnormal condition can be detected by the second abnormal condition determination processing if the failure occurs before the signal change of the second detection switch 48B (shown by “S2” in FIGS. 12 and 13) or the abnormal condition can be detected by the third abnormal condition determination processing executed at the end of the operation if the failure occurs after the signal change of the second detection switch 48B. It should naturally be understood that a completion of the unlocking operation can normally be confirmed by the signal change by the second detection switch 48B and by an elapse of the second set time.

In the case where the first detection switch 48A already has a failure in a short-circuited state at the start of the unlocking operation, the abnormal condition cannot be detected by the first abnormal condition determination processing executed at the start of the operation. However, after the start of the operation, the abnormal condition can be detected by the second abnormal condition determination processing and the third abnormal condition determination processing. Moreover, in the case where the first detection switch 48A fails in the short-circuited state after the start of the operation, the abnormal condition can be detected by the second abnormal condition determination processing and the third abnormal condition determination processing if the failure occurs before the signal change of the second detection switch 48B or the abnormal condition can be detected by the second abnormal condition determination processing and the third abnormal condition determination processing if the failure occurs after the signal change of the second detection switch 48B. It should naturally be understood that a completion of the unlocking operation can normally be confirmed by the signal change by the second detection switch 48B and by an elapse of the second set time.

Further, in the case where the second detection switch 48B already has a failure in the open state at the start of the unlocking operation, the abnormal condition cannot be detected by the first abnormal condition determination processing executed at the start of the operation. However, after the start of the operation, the abnormal condition can be detected by the second abnormal condition determination processing and the third abnormal condition determination processing. Moreover, in the case where the second detection switch 48B fails in the open state after the start of the operation, the abnormal condition can be detected by the second abnormal condition determination processing, or the third abnormal condition determination processing executed at the end of the operation if the failure occurs before the signal change of the first detection switch 48A, or the abnormal condition can be detected by the third abnormal condition determination processing if the failure occurs after the signal change of the first detection switch 48A. It should naturally be understood that a completion of the unlocking operation can normally be confirmed by the signal change by the first detection switch 48A.

Furthermore, in the case where the second detection switch 48B already has a failure in the short-circuited state at the start of the unlocking operation, the abnormal condition can be detected by the first abnormal condition determination processing and the second abnormal condition determination processing. Moreover, in the case where the second detection switch 48B fails in the short-circuited state after the start of the operation, the abnormal condition can be detected by the second abnormal condition determination processing or the third abnormal condition determination processing if the failure occurs before the signal change of the first detection switch 48A. Alternatively, if the failure occurs after the signal change of the first detection switch 48A, then the failure is the failure that occurs after the second detection switch 48B and the first detection switch 48A normally operate in this order and the unlocking operation is normally completed. Therefore, the failure cannot be detected in the unlocking operation, but the failure can still be detected in the later-described locking operation. It should naturally be understood that a completion of the unlocking operation can normally be confirmed by the signal change by the first detection switch 48A.

In the case where the first detection switch 48A already has a failure in the open state at the start of the locking operation as shown in FIG. 13, the abnormal condition cannot be detected by the fourth abnormal condition determination processing executed at the start of the operation. However, after the start of the operation, the abnormal condition can be detected by the fifth abnormal condition determination processing, and the sixth abnormal condition determination processing executed at the end of the operation. Moreover, in the case where the first detection switch 48A fails in the open state after the start of the operation, the abnormal condition can be detected by the fifth abnormal condition determination processing or the sixth abnormal condition determination processing if the failure occurs before the signal change of the second detection switch 48B, or the abnormal condition can be detected by the sixth abnormal condition determination processing if the failure occurs after the signal change of the second detection switch 48B. It should naturally be understood that a completion of the locking operation can normally be confirmed with the signal change by the second detection switch 48B.

Moreover, in the case where the first detection switch 48A already has a failure in the short-circuited state at the start of the locking operation, the abnormal condition can be detected by the fourth abnormal condition determination processing and the fifth abnormal condition determination processing. Moreover, in the case where the first detection switch 48A fails in the short-circuited state after the start of the operation, the abnormal condition can be detected by the fifth abnormal condition determination processing or the sixth abnormal condition determination processing if the failure occurs before the signal change of the second detection switch 48B. Alternatively, if the failure occurs after the signal change of the second detection switch 48B, then the failure is the failure that occurs after the first detection switch 48A and the second detection switch 48B normally operate in this order and the locking operation is normally completed. Therefore, the failure cannot be detected in the locking operation, but the failure can still be detected in the aforementioned unlocking operation. It should naturally be understood that a completion of the locking operation can normally be confirmed by the signal change by the second detection switch 48B.

Further, in the case where the second detection switch 48B already has a failure in the open state at the start of the locking operation, the abnormal condition can be detected by the fourth abnormal condition determination processing and the fifth abnormal condition determination processing. Moreover, in the case where the second detection switch 48B fails in the open state after the start of the operation, the abnormal condition can be detected by the fifth abnormal condition determination processing if the failure occurs before the signal change of the first detection switch 48A, or the abnormal condition can be detected by the sixth abnormal condition determination processing if the failure occurs after the signal change of the first detection switch 48A. It should naturally be understood that a completion of the unlocking operation can normally be confirmed by the signal change by the first detection switch 48A and by an elapse of the second set time.

Furthermore, in the case where the second detection switch 48B already has a failure in the short-circuited state at the start of the locking operation, the abnormal condition cannot be detected by the fourth abnormal condition determination processing executed at the start of the operation. However, after the start of the operation, the abnormal condition can be detected by the fifth abnormal condition determination processing and the sixth abnormal condition determination processing. Moreover, in the case where the second detection switch 48B fails in the short-circuited state after the start of the operation, the abnormal condition can be detected by the fifth abnormal condition determination processing and the sixth abnormal condition determination processing if the failure occurs before the signal change of the first detection switch 48A, or the abnormal condition can be detected by the fifth abnormal condition determination processing or the sixth abnormal condition determination processing if the failure occurs after the signal change of the first detection switch 48A. It should naturally be understood that a completion of the unlocking operation can normally be confirmed by the signal change by the first detection switch 48A and by an elapse of the second set time.

Thus, in the present invention, the first and fourth abnormal condition determination processings for determining the presence of abnormal conditions based on input signals at the start of the unlocking operation and the locking operation, the second and fifth abnormal condition determination processings for determining the presence of abnormal conditions based on the order of signal changes of the detection switches 48A, 48B and on the second set time, the third and sixth abnormal condition determination processings for determining the presence of abnormal condition based on input signals at the end of the operation are executed. Add to this, in the third and sixth abnormal condition determination processings, the presence of abnormal conditions is further determined based on an actual detection time difference between two detection switches 48A, 48B and a preset allowable range of the time difference. Therefore, it is made possible to credibly determine the presence of failures in the detection switches 48A, 48B during the one operation. As a result, it becomes possible to cope with the aftermath of the failure with expedition.

More specifically, in the case where the failures of the detection switches 48A, 48B are detected during a shifting operation from the locked state to the unlocked state, the lock bolt 23 is prevented from shifting again to the locked position. Moreover, in the case where failures of the detection switches 48A, 48B are detected at the start of a shifting operation from the unlocked state to the locked state, the locking operation is immediately cancelled. Further, in the case where failures of the detection switches 48A, 48B are detected after the start of the shifting operation from the unlocked state to the locked state, a subsequent locking operation is not executed once the locking operation is completed and a next unlocking operation is executed. As a result, it is possible to prevent the lock bolt 23 from becoming the inoperable state at the locked position and from making the automobile incapable of running.

It is to be noted that the steering lock device in the present invention is not limited to the structure disclosed in the above embodiment but is capable of various modifications.

For example, in the embodiment disclosed, in the case where the abnormal conditions of the detection switches 48A, 48B are detected during unlocking operation, a subsequent locking operation is no longer executable, and in the case where the abnormal conditions of the detection switches 48A, 48B are detected at the start of the locking operation, a subsequent locking operation including the current locking operation is no longer executable. However, these subsequent locking operations may be made executable. In that case, since the other detection switch 48A or 48B has the potential to have abnormal conditions, subsequent locking operation and unlocking operation should preferably be operated based on the first set time.

Further, although in the embodiment disclosed above, the locking or unlocking operation of the lock device is performed in conjunction with key operation for starting or stopping the engine, it may be performed in conjunction with key operation of a door lock device. It should naturally be understood that in the case of automobiles for controlling opening/closing of the door lock device with a remote controller, the locking or unlocking operation of the steering lock device may be performed in conjunction with the opening/closing control of the door. Further, in the case of automobiles incorporating an immobilizer employing electric key matching, the unlocking operation of the steering lock device may be executed upon authentication through the key matching, whereas the locking operation of the steering lock device may be executed in an unauthenticated state.

Furthermore, although in the embodiment described above, the steering shaft 1 is applied as a movable member rotating along with the rotating operation of an unshown steering, the steering shaft 1 may be replaced with other interlocking members.

Although the present invention has been fully described by way of examples with reference to the accompanying drawings, it is to be noted that various changes and modifications will be apparent to those skilled in the art. Therefore, unless otherwise such changes and modifications depart from the spirit and the scope of the present invention, they should be construed as being included therein.

What is claimed is:

1. A steering lock device, comprising:
a lock bolt for locking or unlocking a steering upon engagement with a movable member that operates in conjunction with operation of the steering or upon release from the engagement;
first and second position detection members for detecting an operating position of the lock bolt;
a position determination member for determining an operating state of the lock bolt based on detection signals from the position detection members,
the first and second position detection members being so placed as to generate a time difference between a point of time when a locked position and an unlocked position of the lock bolt are detected by the first position detection member and a point of time when the locked position and the unlocked position of the lock bolt are detected by the second position detection member; and
a failure determination member for determining a presence of a failure of the first or second position detection member based on an actual detection time difference by the first and second position detection members and on a preset allowable range of the time difference.

2. The steering lock device according to claim 1,
wherein when it is determined by the failure determination member that the first or second position detection member has a failure, a shifting operation of the lock bolt to the locked state is prohibited.

3. The steering lock device according to claim 2,
wherein when it is determined that the first or second position detection member has a failure during a shifting operation of the lock bolt from the locked state to the unlocked state, a shifting operation of the lock bolt to the locked state after completion of an unlocking operation is prohibited.

4. The steering lock device according to claim 2,
wherein when it is determined that the first or second position detection member has a failure at a start of a shifting operation of the lock bolt from the unlocked state to the locked state, the shifting operation of the lock bolt to the locked state is prohibited.

5. The steering lock device according to claim 2,
wherein when it is determined that the first or second position detection member has a failure after a start of a shifting operation of the lock bolt from the unlocked state to the locked state, a next shifting operation to the locked state is prohibited once the shifting operation of the lock bolt to the locked state is completed and then a shifting operation of the lock bolt to the unlocked state is completed.
